(19) United States
(12) Patent Application Publication
(10) Pub. No.: US 2017/0084170 A1
(43) Pub. Date: Mar. 23, 2017

(54) GESTURE-ENABLED REMOTE CONTROL SIGNAL GENERATION

(71) Applicant: College of William and Mary, Williamsburg, VA (US)

(72) Inventors: Gang Zhou, Williamsburg, VA (US); Hongyang Zhao, Williamsburg, VA (US)

(21) Appl. No.: 14/860,912

(22) Filed: Sep. 22, 2015

(51) Int. Cl. G08C 17/02

(52) U.S. Cl. CPC G08C 17/02; G08C 2201/32

(57) ABSTRACT

Gesture-enabled remote control is implemented using a portable device having motion sensors and a wireless transmitter. An activation signal is received when the motion sensors detect a first prescribed motion of the portable device. A neutral orientation is then assigned to the portable device. The neutral orientation is defined by a position of the portable device at the time the activation signal is received. A control signal is generated when the motion sensors detect one of a plurality of prescribed movements of the portable device occurring within a prescribed window of time. Each prescribed movement includes movement of the portable device away from the neutral orientation and then back to the neutral orientation. The control signal is formatted for wireless transmission to an electronic device for control thereof.

### STATEMENT REGARDING FEDERALLY SPONSORED RESEARCH AND DEVELOPMENT

This invention was made with government support under Grant No. CNS1253506 awarded by the National Science Foundation. The government has certain rights in the invention.

### CROSS-REFERENCE TO RELATED APPLICATIONS

Not applicable

### FIELD OF INVENTION

The field of the invention relates generally to signal generation for use in the remote control of electronic devices, and more particularly to remote control signal generation that uses gestures to enable and control the generation of remote control signals.

### BACKGROUND OF THE INVENTION

Many of today's products and devices include electronic control systems that can be remotely operated by a specific, hand-held wireless remote controller. Products/devices that can routinely use wireless remote controllers include, but are not limited to, televisions, audio systems, video playback systems, remote control toys such as toy cars/boats/planes, and household products/appliances such as fans, air conditioners, etc. For a typical household, this leads to a plethora of remote controllers requiring batteries and routine battery replacement. Further, the free-standing nature and relatively small size of many remote controllers leads to their misplacement and user frustration when they “can't find the remote”.

### BRIEF SUMMARY OF THE INVENTION

Accordingly, it is an object of the present invention to provide a means to leverage existing technology to remotely control a variety of products and devices.

Another object of the present invention is to provide a means to utilize smartwatches and smartphones for remote control operations.

In accordance with the present invention, a method is provided for executing a computer program on a processor onboard a portable device having motion sensors and a wireless transmitter to generate a control signal for reception by an electronic device. The method includes the step of receiving, from the motion sensors, an activation signal when the motion sensors detect a first prescribed motion of the portable device. A neutral orientation is then assigned to the portable device at the time the activation signal is received. The neutral orientation is defined by a position of the portable device at the time the activation signal is received. A control signal is generated when the motion sensors detect one of a plurality of prescribed movements of the portable device occurring within a prescribed window of time. Each prescribed movement includes movement of the portable device away from the neutral orientation and then back to the neutral orientation. The control signal is formatted for wireless transmission to an electronic device and recognition by the electronic device for controlling an operation of the electronic device.

### BRIEF DESCRIPTION OF THE DRAWINGS

The summary above, and the following detailed description, will be better understood in view of the drawings that depict details of preferred embodiments.

FIG. 1 is a schematic view of a system architecture for implementing gesture-enabled remote control signal generation in accordance with an embodiment of the present invention;

FIG. 2 is a schematic view of software modules for implementing gesture-enabled remote control signal generation in accordance with an embodiment of the present invention;

FIG. 3 is an isolated schematic view of a portable device sequenced through a series of motions used to define an activation signal and neutral orientation in accordance with an embodiment of the present invention;

FIG. 4 is an isolated schematic view of the portable device indicating four prescribed remote-control movements in accordance with an embodiment of the present invention;

FIG. 5 is an isolated schematic view indicating another prescribed remote-control movement;

FIG. 6 is a schematic view of a user's arm wearing a smartwatch illustrating activating motions, a neutral orientation, and several prescribed remote-control movements in accordance with an embodiment of the present invention; and

FIG. 7 is a schematic view of the user's arm and smartwatch illustrating additional prescribed remote-control movements.

### DETAILED DESCRIPTION OF THE INVENTION

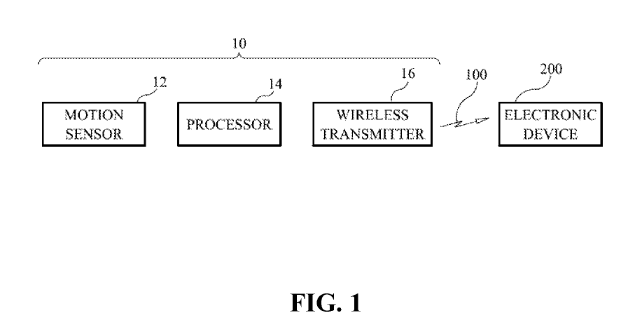

Referring now to the drawings and more particularly to FIG. 1, a system architecture for implementing gesture-enabled remote control in accordance with an embodiment of the present invention is shown and is referenced generally by numeral 10. As used herein, the word “gesture” refers to prescribed motions or movements of a user that bring about corresponding movements of a portable device that can sense and distinguish the prescribed movements. For purposes of description and by way of example, system architecture 10 can be found on existing portable devices such as smartwatches and smartphones. That is, it will be assumed herein that a user, during the course of the prescribed movements, is either wearing (e.g., in the case of a smartwatch) or holding (e.g., in the case of a smartphone) the portable device that includes a system architecture 10.

System architecture 10 includes one or more motion sensors 12 for detecting the above-mentioned prescribed movements, a processor 14 coupled to sensors 12 for receiving signals from sensors 12 that are indicative of the prescribed movements and for performing programmed processing to be described further below, and a wireless transmitter 16 for generating wireless control signals 100. In general, when system architecture 10 implements programming in accordance with the present invention, a user's gesture-based movements of the portable device embodying system architecture 10 (i.e., movement of sensors 12) are converted to wireless control signals 100 that are formatted for recognition and use by an electronic device 200 to control operation of device 200.

Motion sensors 12 can include one or more accelerometers, one or more gyroscopes, and/or one or more magnetometers. Such sensors are readily found on commercially-available smartwatches and smartphones. The particular types, numbers, and configurations of sensors 12 are not limitations of the present invention. Processor 14 is an onboard processor typically found on commercially-available portable devices to include smartwatches and smartphones. Wireless transmitter 16 can be any of a variety of transmitters to include radio, Wi-Fi and BLUETOOTH-based transmitters, without departing from the scope of the present invention. Electronic device 200 is any of a variety of products/systems that can be partially or completely controlled by wireless signals typically generated by some type of hand-held remote control unit. Accordingly, device 200 can include, but is not limited to, audio/video products/systems, household products/appliances, remotely-controlled toys and vehicles, etc.

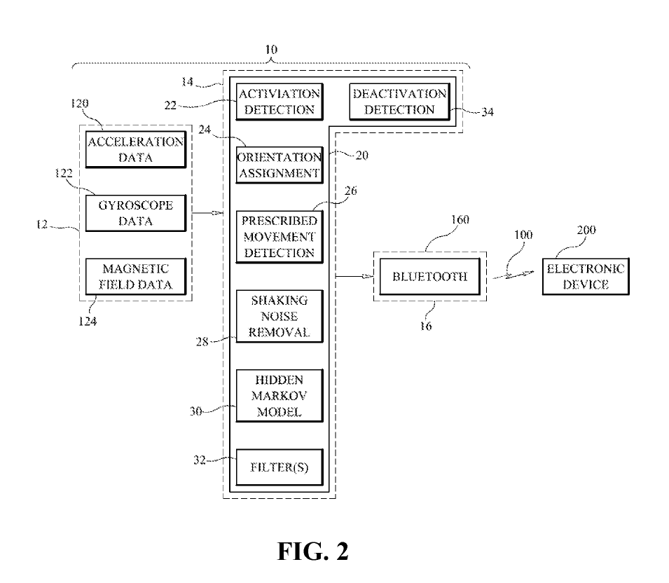

FIG. 2 illustrates an embodiment of software modules 20 that can be programmed into processor 14 for implementing gesture-enabled remote control. It is to be understood that the separating of software modules 20 into distinct “blocks” is merely to facilitate a description and understanding of the present invention. Accordingly, it is to be understood that the functions indicated by the distinct blocks could be incorporated into one or more of the other blocks without departing from the scope of the present invention.

Software modules 20 process one or more of acceleration data 120, gyroscope data 122, and magnetic field data 124 produced by motion sensors 12 when data 120/122/124 is indicative of one of the prescribed motions or movements that is associated with the gesture-enabled remote control. The particular combination/configuration of data 120/122/124 indicative of each prescribed motion or movement is not a limitation of the present invention, but such data should be discernable as being indicative of a particular prescribed movement. For example, a specific one or more of data 120/122/124 can be used to trigger or activate gesture-enabled remote control processing. That is, once the specific activation data/signal is received at an activation detection module 22, gesture-enabled remote control is triggered or enabled for performance by the remaining ones of modules 20.

Briefly, an orientation assignment module 24 first processes incoming data 120/122/124 at the time activation detection module 22 is triggered in order to establish or assign the position of the portable device (i.e., using data from sensors 12) incorporating system architecture 10. This established/assigned position defines a neutral orientation of the portable device that is analogous to defining an origin in a coordinate system. Once the neutral orientation of the portable device is assigned, a prescribed movement detection module 26 “monitors” data 120/122/124 to see if a prescribed “remote control” movement of the portable device is detected. In general, each such prescribed remote-control movement is defined by the portable device being moved away from the assigned neutral orientation and then back to the neutral orientation. When data 120/122/124 indicates such a prescribed movement, the present invention generates wireless control signal 100 that can control an electronic device 200.

By way of an exemplary embodiment, the conversion of data 120/122/124 indicative of a prescribed remote-control movement to remote control data transmitted as wireless control signal 100 can be accomplished with a shaking noise removal module 28, a Hidden Markov Model (HMM) module 30, and a filter(s) module 32. As mentioned above, the functions provided by these modules can be incorporated or embedded in one or more of the other portions of the software modules 20 without departing from the scope of the present invention.

Sensor data 120/122/124 can include informational “noise” when the portable device (that generates the sensor data) shakes during a prescribed remote-control movement. For example, if the portable device is a smartwatch that is being worn loosely on one's wrist, shaking noise can be included with data 120/122/124. Accordingly, shaking noise removal module 28 is provided to detect and remove such noise thereby improving the effectiveness of prescribed movement detection module 26. Sensor data 120/122/124 is normalized to the above-mentioned neutral orientation by orientation assignment module 24. The sensor data is then classified by a set of HMMs in HMM module 30. Each such HMM is trained for a specific gesture that is to be classified. The HMMs can be initially trained and preloaded and/or they can be subject to re-training by a specific user without departing from the scope of the present invention. Each of the HMMs in module 30 makes a classification decision. The decision yielding the highest probability that is also greater than a preset threshold defines the gesture's classification. In cases where the preset threshold criteria is not satisfied, filter(s) module 32 can apply a set of empirical rules to make the decision of gesture classification. The gesture classification decision becomes the remote control data (e.g., right arrow, left arrow, up arrow, down arrow, back, or select). The remote control data is provided to wireless transmitter 16 (e.g., a BLUTETOOTH module 160) for output therefrom as wireless control signal 100.

Deactivation of software modules 20 can be effected actively and/or passively without departing from the scope of the present invention. A deactivation module 34 can be triggered when incoming data 120/122/124 is received that indicates a prescribed motion of the portable device (i.e., motion of sensors 12). Such deactivating motion can be the same as that detected by activation detection module 22 (i.e., a toggle on, toggle off scenario) or different from that detected by module 22 without departing from the scope of the present invention. Additionally or alternatively, deactivation detection module 34 can be triggered to “time out” by the lack of prescribed remote-control movements within a window of time after activation has occurred or after the last prescribed remote-control movement was detected. For example, if acceptable prescribed activation/deactivation and remote-control motions/movements must occur within a relatively short time window (e.g., approximately one second or less), then a window of time indicative of a lack of such motions/movements could be triggered by a longer of window of time, e.g., on the order of approximately 2 seconds to approximately 10 seconds. In either case, once deactivation detection module 34 has been triggered, processing by modules 28, 30 and 32 ceases or is prevented until such time that activation detection module 22 again receives data 120/122/124 to re-start the gesture-enabled remote control processing.

In addition to controlling commencement and cessation of processing, activation detection module 22 and deactivation detection module 34 can be used to enable and disable, respectively, wireless transmitter 16. That is, wireless transmitter 16 could be enabled when activation data 120/122/124 is received by module 22, and could be disabled when deactivation data 120/122/124 is received by module 34 or when module 34 indicates a “time out” condition. By incorporating the enablement/disablement of wireless transmitter 16 in the present invention, power can be conserved for the portable device.

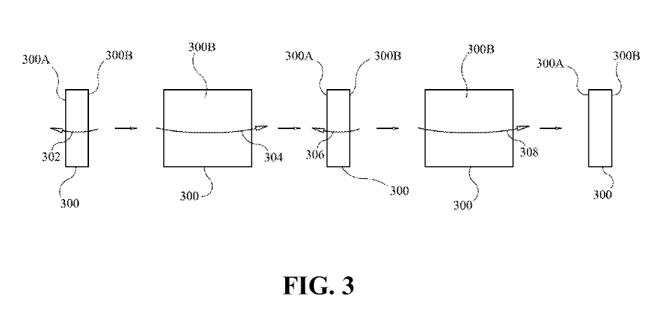

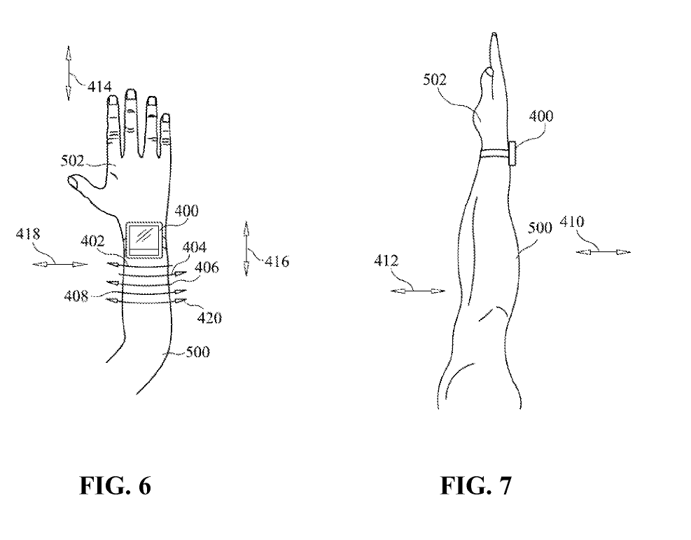

The above-described prescribed motions or movements can be defined in a variety of ways. By way of a non-limiting example, a set of motions/movements for activating/deactivating gesture-enabled remote control and for generating remote control signals will be described with the aid of FIGS. 3-7. In FIGS. 3-5, a portable device 300 is shown in isolation going through an exemplary set of motions/movements. Portable device 300 is assumed to incorporate the above-described system architecture 10 programmed with software modules 20. In FIGS. 6-7, a user wearing a smartwatch 400 is illustrated along with the exemplary set of motions/movements for gesture-enabled remote control. Smartwatch 400 is also assumed to incorporate system architecture 10 programmed with software modules 20.

Activation (and deactivation) of gesture-enabled remote control should be realized with simple yet purposeful and non-ordinary motions of a portable device (e.g., smartwatch, smartphone, etc.) to prevent unintentional activation/deactivation. In the embodiment illustrated in FIG. 3, portable device 300 is sequenced through a series of motions that will essentially generate sensor data (e.g., data 120/122/124) that define an activation signal. The motions depicted in FIG. 3 satisfy the simple, purposeful, and non-ordinary criteria. The sequence illustrated in FIG. 3 progresses from left to right. Briefly, during the course of the sequence, portable device 300 is partially rotated in alternating directions two times. More specifically and starting from the far left side of FIG. 3, portable device 300 is shown in a side view thereof with front face 300A and back face 300B being indicated. Portable device 300 is then partially rotated (e.g., approximately 90 degrees) as indicated by directional arrow 302 such that back face 300B becomes visible as shown. Then, portable device 300 is rotated back as indicated by directional arrow 304. This sequence is then repeated as indicated with directional arrows 306 and 308 whereby portable device 300 is in the position/orientation as shown in the far right side of FIG. 3. To define the FIG. 3 sequence of motions as purposeful and non-ordinary, it is desirable for the entire sequence to occur in a relatively short period of time such as approximately one second or less.

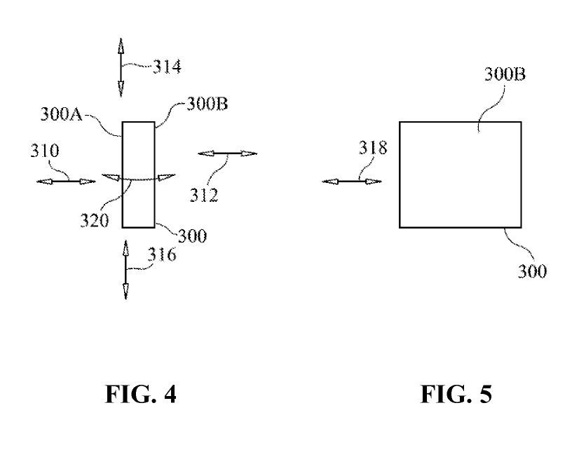

In addition to defining the activation signal, completion of the sequence in FIG. 3 provides the neutral orientation of portable device 300 thereby defining the origin for all remote-control gesture movements. That is, the final rightmost position or orientation (defined by data from the motion sensors onboard portable device 300) of portable device 300 at the conclusion of the sequence in FIG. 3 becomes the neutral orientation for the gesture-enabled remote control. Exemplary prescribed movements of portable device 300 for use in remote control signal generation are presented in FIGS. 4 and 5 where such movements can occur in any order after the activation motions of FIG. 3 are detected. Since many remote controls include a left arrow, a right arrow, an up arrow, a down arrow, a back button, and a select button, the prescribed movements of portable device 300 shown in FIGS. 4 and 5 recreate these controls.

In accordance with the present invention, each of the prescribed remote-control movements is a specific movement away from the neutral orientation and then back to the neutral orientation. To assure that each “away from” and “back to” sequence is non-ordinary and purposeful, it is desirable for each such sequence to occur in a relatively short period of time such as approximately one second or less. For the illustrated example, a remote control's “left arrow” gesture is defined by left-then-right arrow 310, a remote control's “right arrow” gesture is defined by right-then-left arrow 312, a remote control's “up arrow” gesture is defined by up-then-down arrow 314, a remote control's “down arrow” gesture is defined by down-then-up arrow 316, and a remote control's “back button” gesture is defined by back-then-forward arrow 318 (as viewed from the orientation of device 300 shown in FIG. 5.) The direction-specific back-and-return movements defined by gestures 310-318 lie in orthogonal planes thereby making them both readily distinguishable by the portable device's motion sensors and intuitive for a user. A “select button” gesture can be defined by a single partial rotation in alternating directions as indicated by two-headed alternating-direction rotation arrow 320. In other words, the “select button” gesture can be defined by one-half of the motions used to create an activation signal thereby reducing the types of motions/movements for a user to remember.

Referring now to FIGS. 6 and 7, a user's right arm 500 has smartwatch 400 affixed thereto as shown. It is to be understood that a user could alternatively wear smartwatch 400 on their left arm without departing from the scope of the present invention. For purpose of illustration, arm 500 is shown in a bent position with hand 502 pointing upward. In FIGS. 6 and 7, prescribed motions/movements analogous to those described above for arrows 302-320 are referenced by arrows 402-420, respectively. Accordingly, an activation signal is created when smartwatch 400 undergoes two alternating-direction partial rotations as indicated by the sequence of directional arrows 402-408 that are analogous to the partial rotations previously described/shown using arrows 302-308. The neutral orientation of smartwatch 400 is defined at the conclusion of partial rotation 408. From this neutral orientation, prescribed remote-control movements are indicated by arrows 410-420 that are analogous to the movements previously described/shown using arrows 310-320.

The advantages of the present invention are numerous. Gesture-enabled remote control signal generation leverages readily-available portable devices to facilitate wireless control of a variety of electronic devices. Simple and intuitive gesture-based movements of a smartwatch, smartphone, etc., eliminate the need to pick-up a particular remote controller. In the case of a smartwatch, a user does not even need to hold the device generating the remote control signals.

Incorporation by Reference

All publications, patents, and patent applications cited herein are hereby expressly incorporated by reference in their entirety and for all purposes to the same extent as if each was so individually denoted.

Equivalents

While specific embodiments of the subject invention have been discussed, the above specification is illustrative and not restrictive. Many variations of the invention will become apparent to those skilled in the art upon review of this specification. The full scope of the invention should be determined by reference to the claims, along with their full scope of equivalents, and the specification, along with such variations.

We claim:

1. A method for executing a computer program on a processor onboard a portable device having motion sensors and a wireless transmitter to generate a control signal for reception by an electronic device, said method comprising the steps of:
receiving, from the motion sensors, an activation signal when the motion sensors detect a first prescribed motion of the portable device;
assigning a neutral orientation to the portable device at the time said activation signal is received, said neutral orientation defined by a position of the portable device at the time said activation signal is received; and
generating a control signal when the motion sensors detect one of a plurality of prescribed movements of the portable device occurring within a prescribed window of time, each of said prescribed movements including movement of the portable device away from said neutral orientation and then back to said neutral orientation, wherein said control signal is formatted for wireless transmission to an electronic device and recognition by the electronic device for controlling an operation of the electronic device.

2. A method according to claim 1 further comprising, after said step of receiving, the steps of:
receiving a deactivation signal from the motion sensors when the motion sensors detect a second prescribed motion of the electronic device; and
preventing occurrence of said step of generating said control signal after said deactivation signal is received.

3. A method according to claim 2, wherein said second prescribed motion is different than said first prescribed motion.

4. A method according to claim 2, wherein said second prescribed motion is identical to said first prescribed motion.

5. A method according to claim 1 further comprising, after said step of receiving, the steps of:
generating a deactivation signal when none of said prescribed movements are detected by the motion sensors within a second prescribed window of time after said activation signal is received; and
preventing occurrence of said step of generating said control signal after said deactivation signal is generated.

6. A method according to claim 1, wherein said first prescribed motion of the portable device comprises at least four alternating-direction partial rotations of the portable device.

7. A method according to claim 2, wherein said second prescribed motion of the portable device comprises two alternating-direction partial rotations of the portable device.

8. A method according to claim 1, wherein said plurality of prescribed movements include movements of the portable device that lie approximately in orthogonal planes.

9. A method according to claim 1, wherein said plurality of prescribed movements include a movement defined by two alternating-direction partial rotations of the portable device.

10. A method according to claim 1, wherein said plurality of prescribed movements comprise:
movements of the portable device that lie approximately in orthogonal planes; and
a movement defined by two alternating-direction partial rotations of the portable device.

11. A method according to claim 1, wherein said prescribed window of time is less than approximately one second.

12. A method according to claim 5, wherein said second prescribed window of time is between approximately 2 seconds and approximately 10 seconds.

13. A method according to claim 1, further comprising the step of enabling the wireless transmitter after said activation signal is received.

14. A method according to claim 2, further comprising the steps of:
enabling the wireless transmitter after said activation signal is received; and
disabling the wireless transmitter after said deactivation signal is received.

15. A method according to claim 5, further comprising the steps of:
enabling the wireless transmitter after said activation signal is received; and
disabling the wireless transmitter after said deactivation signal is generated.

16. A computer usable medium comprising a computer program code which is configured to cause a processor onboard a portable device having motion sensors and a wireless transmitter to execute one or more functions comprising:
receiving, from the motion sensors, an activation signal when the motion sensors detect a first prescribed motion of the portable device;
assigning a neutral orientation associated with the portable device at the time said activation signal is received, said neutral orientation defined by a position of the portable device at the time said activation signal is received; and
generating a control signal when the motion sensors detect one of a plurality of prescribed movements of the portable device occurring within a prescribed window of time, each of said prescribed movements including movement of the portable device away from said neutral orientation and then back to said neutral orientation, wherein said control signal is formatted for wireless transmission to an electronic device and recognition by the electronic device for controlling an operation of the electronic device.

17. A computer usable medium as in claim 16 further comprising, after said function of receiving said activation signal, the functions of:
receiving a deactivation signal from the motion sensors when the motion sensors detect a second prescribed motion of the electronic device; and
preventing occurrence of said function of generating after said deactivation signal is received.

18. A computer usable medium as in claim 16, wherein said second prescribed motion is different than said first prescribed motion.

19. A computer usable medium as in claim 17, wherein said second prescribed motion is identical to said first prescribed motion.

20. A computer usable medium as in claim 16 further comprising, after said function of receiving said activation signal, the functions of:
generating a deactivation signal when none of said prescribed movements are detected by the motion sensors within a second prescribed window of time after said activation signal is received; and
preventing occurrence of said function of generating said control signal after said deactivation signal is generated.

21. A computer usable medium as in claim 16, wherein said first prescribed motion of the portable device comprises at least four alternating-direction partial rotations of the portable device.

22. A computer usable medium as in claim 17, wherein said second prescribed motion of the portable device comprises two alternating-direction partial rotations of the portable device.

23. A computer usable medium as in claim 16, wherein said plurality of prescribed movements include movements of the portable device that lie approximately in orthogonal planes.

24. A computer usable medium as in claim 16, wherein said plurality of prescribed movements include a movement defined by two alternating-direction partial rotations of the portable device.

25. A computer usable medium as in claim 16, wherein said plurality of prescribed movements comprise:
movements of the portable device that lie approximately in orthogonal planes; and
a movement defined by two alternating-direction partial rotations of the portable device.

26. A computer usable medium as in claim 16, wherein said prescribed window of time is less than approximately one second.

27. A computer usable medium as in claim 17, wherein said second prescribed window of time is between approximately 2 seconds and approximately 10 seconds.

28. A computer usable medium as in claim 16 further comprising, after said function of receiving said activation signal, the function of enabling the wireless transmitter after said activation signal is received.

29. A computer usable medium as in claim 17 further comprising, after said function of receiving said activation signal, the functions of:
enabling the wireless transmitter after said activation signal is received; and
disabling the wireless transmitter after said deactivation signal is received.

30. A computer usable medium as in claim 20 further comprising, after said function of receiving said activation signal, the functions of:
enabling the wireless transmitter after said activation signal is received; and
disabling the wireless transmitter after said deactivation signal is generated.

31. A software arrangement which is operable on a processor onboard a portable device having motion sensors and a wireless transmitter, the software arrangement comprising a computer program which configures the processor to perform one or more functions comprising:
receiving, from the motion sensors, an activation signal when the motion sensors detect a first prescribed motion of the portable device;
assigning a neutral orientation associated with the portable device at the time said activation signal is received, said neutral orientation defined by a position of the portable device at the time said activation signal is received; and
generating a control signal when the motion sensors detect one of a plurality of prescribed movements of the portable device occurring within a prescribed window of time, each of said prescribed movements including movement of the portable device away from said neutral orientation and then back to said neutral orientation, wherein said control signal is formatted for wireless transmission to an electronic device and recognition by the electronic device for controlling an operation of the electronic device.
